(19) United States
(12) Patent Application Publication
(10) Pub. No.: US 2009/0077242 A1
(43) Pub. Date: Mar. 19, 2009

(54) METHOD, TERMINAL, DEVICE AND SYSTEM FOR OBTAINING ID INFORMATION OF APPLICATION SERVICE

(75) Inventor: Fei LIN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/326,215

(22) Filed: Dec. 2, 2008

Related U.S. Application Data
(63) Continuation of application No. PCT/CN2007/002191, filed on Jul. 18, 2007.

(30) Foreign Application Priority Data
Oct. 20, 2006 (CN) 200610140279.9

(51) Int. Cl. G06F 15/16; G06F 7/58

(52) U.S. Cl. 709/227; 726/4

(57) ABSTRACT

The present invention discloses a method, a terminal, a device, and a system for obtaining ID information of an application service to solve the problem of the prior art that a terminal cannot automatically obtain the ID information of a target application service. In the invention, a first device sends an ID request to a second device, and the second device returns the ID information of the target application service to the first device. By the technical solution of the invention, a terminal which acts as the first device may automatically obtain the ID information of the target application service, and the user experience satisfaction is improved.

### CROSS-REFERENCE TO RELATED APPLICATIONS

This application is a continuation of International Patent Application No. PCT/CN2007/002191, filed Jul. 18, 2007, which claims priority to Chinese Patent Application No. 200610140279.9, filed Oct. 20, 2006, both of which are hereby incorporated by reference in their entirety.

### FIELD OF THE INVENTION

The present invention relates to the technical field of network communications, and in particular, to a method, a terminal, a device, and a system for obtaining ID information of an application service.

### BACKGROUND OF THE INVENTION

As a Next Generation Converged Network, an Internet protocol Multimedia Subsystem (IMS) enables an operator to rapidly and efficiently dispose various converged multimedia services with the service innovation as the driving force. When a terminal user experiences multimedia services, the ID information of the application service needs to be filled in by the terminal user. For example, when a user carries out PTT over Cellular (PoC) service, Message service, and Conference service, the ID information of the corresponding application service needs to be provided.

The format of Public Service Identity (PSI) may be a SIP URI, which identifies a kind of service resource, similar with a SIP URI account of a SIP user.

At present, when a terminal user experiences a certain service which requires the ID information of the application service, the terminal user may obtain the ID information of the corresponding application service on a web site provided by the operator via Portal and then manually input the ID information of the application service as configuration information during the running of a program.

The inventors find that, after the ID information of the application service is obtained by the above technical solution, the terminal user needs to manually input the ID information of the application service, and the terminal user may feel inconvenient. Moreover, because the format of the ID information of the application service has a rather high degree of specialization, such as sip:poc-factory@example.com. It is difficult for the terminal user to understand the format and correctly input the ID information of the application service, and the terminal user may feel more inconvenient. Furthermore, if the ID information of the application service changes, the terminal user is unable to correctly experience the multimedia service. At this point, the terminal user needs to re-obtain the ID information of the application service on a web site provided by the operator via Portal and then again manually input the ID information of the application service as the configuration information during the running of the program. This is extremely troublesome for the terminal user. As a result, the terminal user experience will be bad.

### SUMMARY OF THE INVENTION

The invention provides a method, a terminal, a device, and a system for obtaining ID information of an application service, so as to solve the problem of the prior art that a terminal user cannot automatically obtain the ID information of a target application service.

To solve the above technical problem, the invention provides a method for obtaining ID information of an application service, including:

sending, by a first device, an ID request to a second device; and

returning, by the second device, ID information of a target application service to the first device.

The invention further provides a system for obtaining ID information of an application service, including:

a first device, which includes an ID request module and is adapted to send an ID request to a second device; and

the second device, which includes a processing module and is adapted to return ID information of a target application service to the first device.

The invention further provides a terminal, including a module adapted to run an application, and the terminal further includes an ID request module adapted to send an ID request, according to the application.

The invention further provides a device, including a second receiving module adapted to receive information, and the device further includes a processing module adapted to send ID information of a target application service, according to an ID request received by the second receiving module.

In the invention, by sending the ID request to the second device, the first device may automatically obtain the ID information of the target application service, so that a user does not need to manually input the complex and complicated ID information of the application service when experiencing a service in which the ID information of the corresponding application service needs to be provided. Therefore, the user experience satisfaction may be improved.

### BRIEF DESCRIPTION OF THE DRAWINGS

FIG. 1 is a flow chart of the process in which a user terminal obtains the ID information of an application service according to the first embodiment of the invention;

FIG. 2 is a flow chart of the process in which a user terminal verifies the obtained ID information of the application service with the target application service, according to the first embodiment of the invention;

FIG. 3 is a flow chart of the process in which a user terminal obtains the ID information of an application service, according to the second embodiment of the invention;

FIG. 4 is a flow chart of the process in which a user terminal obtains the ID information of an application service, according to the third embodiment of the invention;

FIG. 5 is a flow chart of the process in which a user terminal verifies the obtained ID information of the application service with a concentrate service;

FIG. 6 is a flow chart of the process in which a user terminal obtains the ID information of an application service, according to the fourth embodiment of the invention;

FIG. 7 is a block diagram of the system for obtaining the ID information of an application service, according to one embodiment of the invention; and

FIG. 8 is a schematic block diagram of a concentrate service which acts as the second device, according to one embodiment of the invention.

### DETAILED DESCRIPTION OF THE EMBODIMENTS

In the invention, a first device sends an ID request to a second device, and the second device returns ID information of the target application service to the first device.

The invention will now be further illustrated in conjunction with the drawings and embodiments.

### Embodiment 1

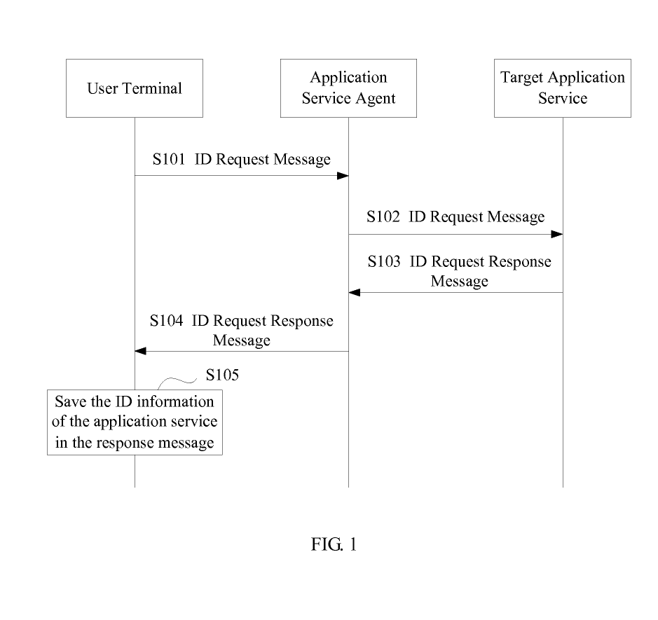

In this embodiment, a user terminal which acts as the first device, obtains the ID information of a target application service by sending an ID request to an application service corresponding to the type of the requested application, i.e. the target application service. In this embodiment, the target application service acts as the second device. When the user activates an application which requires the ID information of corresponding application service referred to in FIG. 1, the process in which the user terminal obtains the ID information of the application service is illustrated, and the process includes the following blocks.

Block S101: A user terminal sends an ID request message carrying the information of the application type to an application service agent.

Block S102: After the application service agent receives the ID request message, the application service agent sends the ID request message to the application service corresponding to the application type, i.e. the target application service, according to the information of the application type carried in the ID request message.

The application service agent is a representative of application services corresponding to different application types. After the application service agent receives the ID request message, the application service agent may determine the application service corresponding to the application type according to the information of the application type carried in the ID request message, and sends the ID request message to the application service corresponding to the application type.

Block S103: The target application service returns an ID request response message carrying the ID information of the target application service to the application service agent.

Block S104: The application service agent sends the response message to the user terminal.

Block S105: After the user terminal receives the response message, the user terminal resolves and saves the ID information of the application service.

The above process may also be performed when the user terminal initiates the first service request after the application is activated. In such a case, the ID request message may be the current service request message or another ID request message. After the user terminal obtains the ID information of the application service, the user terminal may directly interact with the application service during a subsequent service.

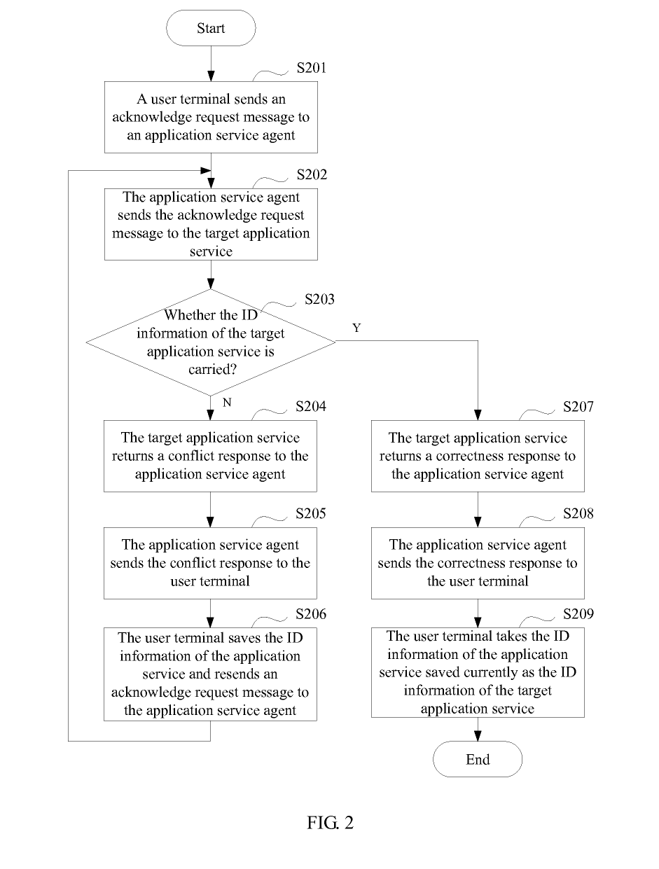

After the user terminal obtains the ID information of the application service, the user terminal may take the ID information of the application service as a correct ID information of the application service corresponding to the application type requested by the user terminal. Alternatively, in order to guarantee the correctness of the ID information of the application service obtained by the user terminal, the user terminal may verify with the target application service whether the ID information is correct after obtaining the ID information of the application service. In this embodiment, FIG. 2 shows the process in which the user terminal verifies the obtained ID information of the application service with the target application service, and includes the following blocks.

Block S201: A user terminal sends a verification request message carrying the ID information of the application service resolved by the user terminal and the information of the application type corresponding to the application to an application service agent.

Block S202: After the application service agent receives the verification request message, the application service agent sends the verification request message to the target application service, according to the information of the application type carried in the verification request message.

Block S203: After the target application service receives the verification request message, the target application service resolves and determines whether the ID information of the application service is carried in the verification request message. If the ID information of the application service is carried in the verification request message, the process turns to Block S207; otherwise, the process turns to Block S204.

Block S204: The target application service returns a conflict response carrying the ID information of the application service to the application service agent.

Block S205: The application service agent sends the conflict response to the user terminal.

Block S206: The user terminal resolves and saves the ID information of the application service carried in the conflict response, and resends a verification request message carrying the ID information of the application service resolved by the user terminal and the information of the application type corresponding to the application, to the application service agent. Then, the process turns to Block S202.

Block S207: The target application service returns a correctness response to the application service agent.

Block S208: The application service agent sends the correct response to the user terminal.

Block S209: The user terminal takes the ID information of the application service saved currently as the ID information of the target application service.

According to the above verifying process, if the target application service does not return the correctness response to the user terminal, the user terminal sends the verification request to the application service continually. During the specific implementation, the times that the user terminal is allowed to initiate the verification request may be limited, for example, 3 times. If no correctness response is obtained after the user terminal sends the verification request to the application service for 3 times, the user terminal may regard that error occurs in the application service agent, the application service or the network transmission and pause requesting the ID information from the target application service, or the user terminal may directly regard that the ID information of the application service saved locally is correct, etc.

During the implementation, the conflict response may not carry the ID information of the application service; thus, the conflict response is only used to notify the user terminal that the ID information of the application service carried in the verification request message is incorrect. Moreover, the verifying process will not be cycled, and will be ended after the user terminal receives the conflict response or the correctness response. After the user terminal determines that the ID information of the application service carried in the verification request message is correct or not, the user terminal may determine, as required, whether to send an ID request message to the target application service again so as to obtain the ID information.

### Embodiment 2

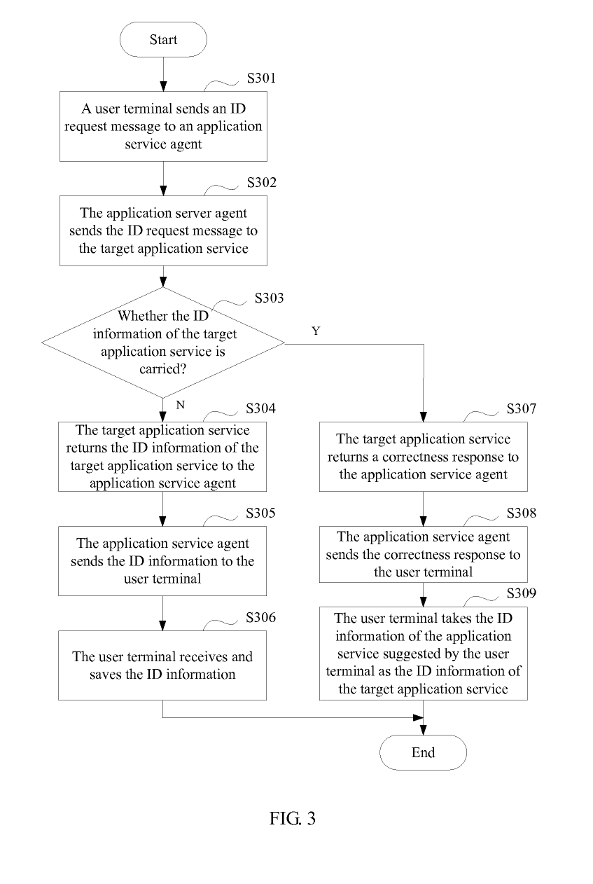

In this embodiment, when a user terminal which acts as the first device obtains the ID information of a target application service which acts as the second device, the user terminal carries the ID information of the application service suggested by the user terminal in the ID request message. FIG. 3 shows the process in which the user terminal obtains the ID information of the application service in this embodiment, and includes the following blocks.

Block S301: A user terminal sends an ID request message carrying the information of the application type corresponding to the application and the ID information of the application service suggested by the user terminal, to an application service agent.

The ID information of the application service suggested by the user terminal, such as sip:wrongname@example.com, may be the ID information of the initial application service of the user terminal or the ID information of the application service which is saved by the user terminal and obtained when the application is run for the last time. The ID information of the initial application service may be generated automatically by the user terminal.

Block S302: After the application service agent receives the ID request message, the application service agent sends the ID request message to the application service corresponding to the application type, i.e. the target application service.

Block S303: After the target application service receives the ID request message, the target application service resolves and determines whether the ID information of the application service suggested by the terminal and carried in the ID request message is the ID information of the target application service. If the ID information of the application service suggested by the terminal and carried in the ID request message is the ID information of the target application service, the process turns to Block S307; otherwise, the process turns to Block S304.

In this block, the target application service may determine whether the ID request message carries the ID information of the target application service. When such a determination mode is employed, the determination may be made no matter whether the ID request carries the ID information of the application service suggested by the user terminal.

In one example, the ID information of the target application service is sip:correctname@example.com, while the ID information of the application service suggested by the user terminal which is carried in the ID request message received by the application service is sip:wrongname@example.com, therefore the application service may determine that the resolved ID information is inconsistent with the ID information of the application service; in other words, the ID information carried in the ID request message is not the ID information of the application service.

Block S304: The target application service returns the ID information of the target application service to the application service agent.

Block S305: The application service agent sends the ID information to the user terminal.

Block S306: The user terminal receives and saves the ID information, and the process ends.

Block S307: The target application service returns a correctness response to the application service agent.

Block S308: The application service agent sends the correctness response to the user terminal.

Block S309: The user terminal takes the ID information of the application service suggested by the user terminal as the ID information of the target application service.

In this embodiment, when the ID information of the application service suggested by the terminal and carried in the ID request message is the ID information of the target application service, the response message which is returned by the target application service to the user terminal may not be the correctness response. For example, the target application service may return the ID information of the target application service to the user terminal. The focus of this process lies in that, when the ID information of the application service suggested by the user terminal and carried in the ID request message is not the ID information of the target application service, the target application service needs to return the ID information of the target application service to the user terminal.

After the user terminal receives the ID information of the target application service, the user terminal may take the ID information as the correct ID information of the target application service, or the user terminal may verify the correctness of the ID information with the target application service again. After the user terminal receives a correctness response from the target application service, the user terminal takes the ID information of the application service as the correct ID information of the target application service. In this embodiment, the process in which the user terminal verifies the obtained ID information of the application service with the application service is the same as that in the first embodiment.

### Embodiment 3

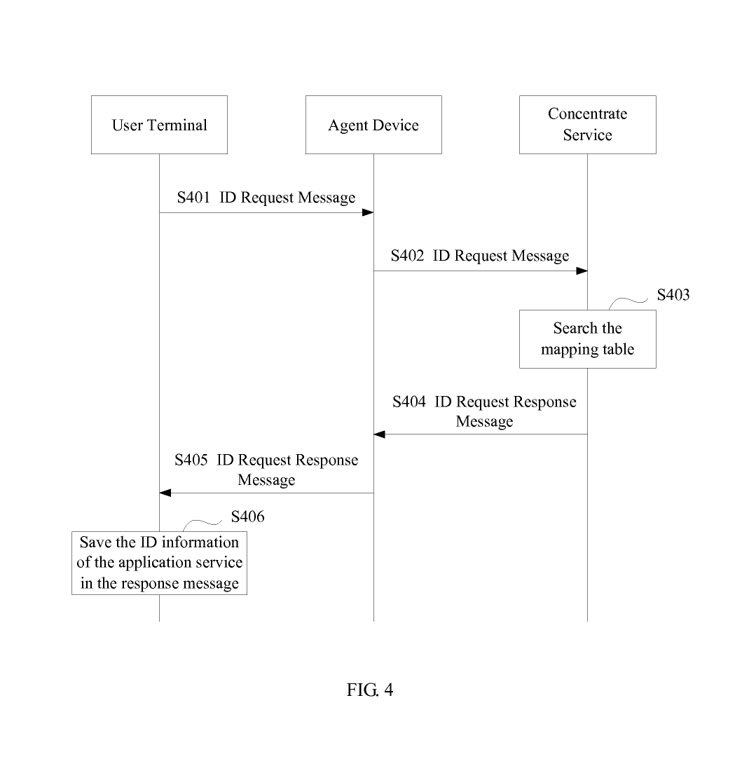

In this embodiment, an operator maintains a concentrate service acts as the second device, and a mapping table indicating the mapping relation between the information of the application type and the ID information of an application service is saved in the second device. A user terminal which acts as the first device may obtain the ID information of the application service from the concentrate service. FIG. 4 shows the process in which the user terminal obtains the ID information of the application service, and includes the following blocks.

Block S401: A user terminal sends an ID request message carrying the information of the application type corresponding to the application to a agent device.

Block S402: After the agent device receives the ID request message, the agent device sends the ID request message to a concentrate service.

Block S403: After the concentrate service receives the ID request message, the concentrate service resolves the information of the application type carried in the ID request message, searches in the mapping table, and obtains the ID information of the application service corresponding to the information of the application type.

Block S404: The concentrate service returns an ID request response message carrying the ID information of the application service to the agent device.

Block S405: The agent device sends the response message to the user terminal.

Block S406: After the user terminal receives the response message, the user terminal resolves and saves the ID information of the application service.

In this embodiment, the function of the agent device merely includes forwarding the ID request message and the ID request response message. Therefore, the agent device may not be used during the implementation.

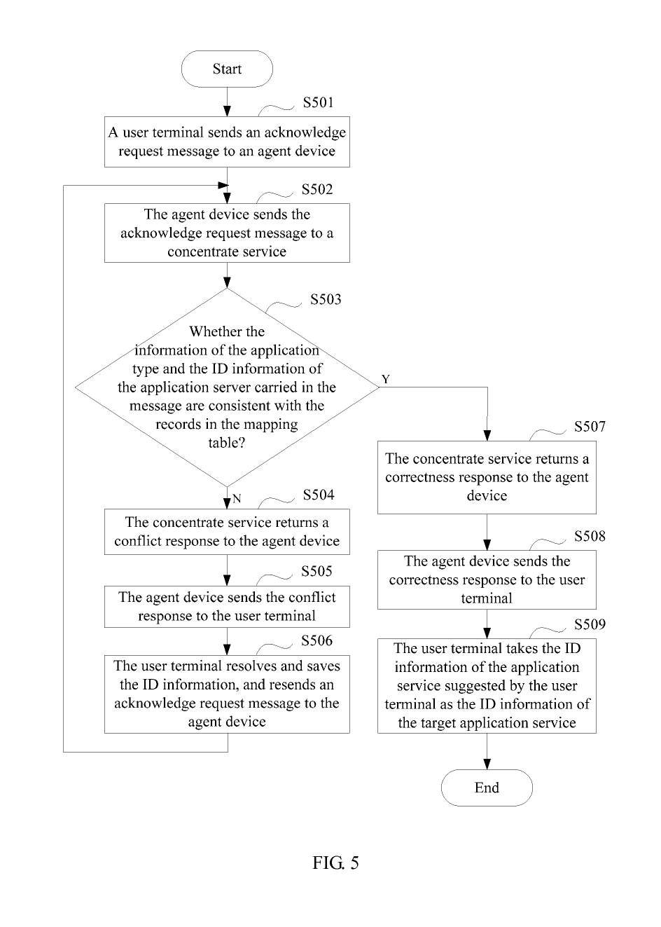

After the user terminal obtains the ID information of the application service, the user terminal may take the ID information of the application service as the correct ID information of the application service corresponding to the application type requested by the user terminal, or the user terminal may verify the application service ID with the concentrate service so as to guarantee the correctness of the ID information of the application service obtained by the user terminal. FIG. 5 shows the process of the verifying method, and includes the following blocks.

Block S501: A user terminal sends a verification request message carrying the ID information of the application service received by the user terminal and the information of the application type corresponding to the application to an agent device.

Block S502: After the agent device receives the verification request message, the agent device sends the verification request message to a concentrate service.

Block S503: After the concentrate service receives the verification request message, the concentrate service resolves and determines whether the information of the application type and the ID information of the application service carried are consistent with the records in the mapping table. If the information of the application type and the ID information of the application service carried are consistent with the records in the mapping table, the process turns to Block S507; otherwise, the process turns to Block S504.

Block S504: The concentrate service returns a conflict response carrying the ID information of the target application service to the agent device.

The concentrate service obtains the ID information of the target application service by searching the mapping table, according to the information of the application type.

Block S505: The agent device sends the conflict response to the user terminal.

Block S506: After the user terminal receives the conflict response, the user terminal resolves and saves the ID information of the application service, and resends a verification request message carrying the ID information of the application service resolved by the user terminal and the information of the application type corresponding to the application, to the agent device. Then, the process turns to Block S502.

Block S507: The concentrate service returns a correctness response to the agent device.

Block S508: The agent device sends the correctness response to the user terminal.

Block S509: The user terminal takes the ID information of the application service suggested by the user terminal as the ID information of the target application service.

Similar to Embodiment 1, in this embodiment, the times that the user terminal is allowed to initiate the verification request may also be limited.

### Embodiment 4

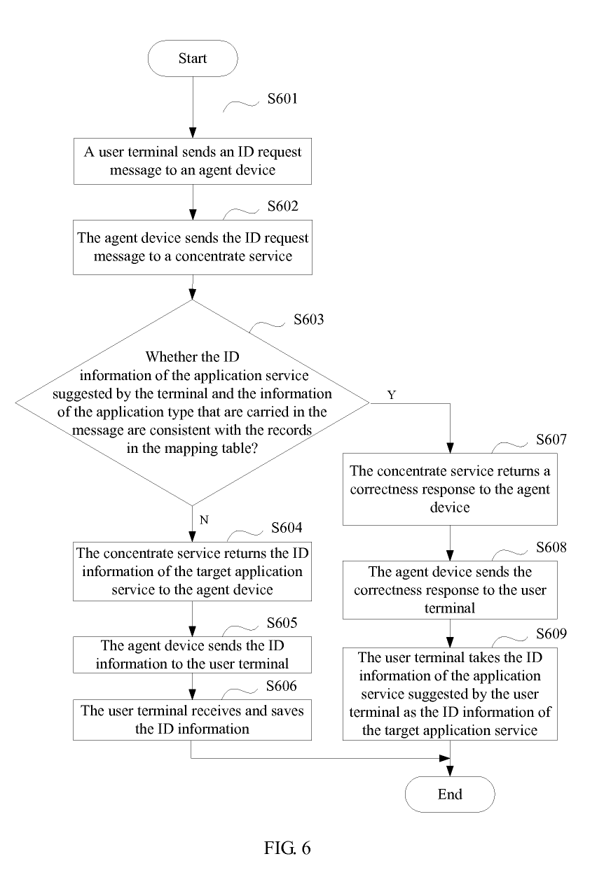

In this embodiment, a user terminal which acts as the first device obtains the ID information of the target application service from a concentrate service which acts as the second device. Moreover, when the user terminal obtains the ID information of the target application service, the user terminal carries the ID information of the application service suggested by the user terminal in the ID request message. FIG. 6 shows the process in which the user terminal obtains the ID information of the application service in this embodiment, and includes the following blocks.

Block S601: A user terminal sends an ID request message carrying the information of the application type corresponding to the application and the ID information of the application service suggested by the user terminal to an agent device.

Block S602: After the agent device receives the ID request message, the agent device sends the ID request message to a concentrate service.

Block S603: After the concentrate service receives the ID request message, the concentrate service resolves and determines whether the ID information of the application service suggested by the user terminal and the information of the application type which are both carried in the ID request message are consistent with the records in the mapping table. If the ID information of the application service suggested by the user terminal and the information of the application type is consistent with the records in the mapping table, the process turns to Block S607; otherwise, the process turns to Block S604.

Block S604: The concentrate service returns the ID information of the target application service to the agent device.

The concentrate service obtains the ID information of the target application service by searching in the mapping table, according to the information of the application type.

Block S605: The agent device sends the ID information to the user terminal.

Block S606: The user terminal receives and saves the ID information of the application service, and the process ends.

Block S607: The concentrate service returns a correctness response to the agent device.

Block S608: The agent device sends the correctness response to the user terminal.

Block S609: The user terminal takes the ID information of the application service suggested by the user terminal as the ID information of the target application service.

After the user terminal receives a conflict response, the user terminal may take the ID information of the application service carried as the correct ID information of the application service corresponding to the application type requested, or the user terminal may verify the application service ID with the concentrate service so as to guarantee the correctness of the ID information of the application service obtained by the user terminal. The verifying method may be the same as that in Embodiment 3.

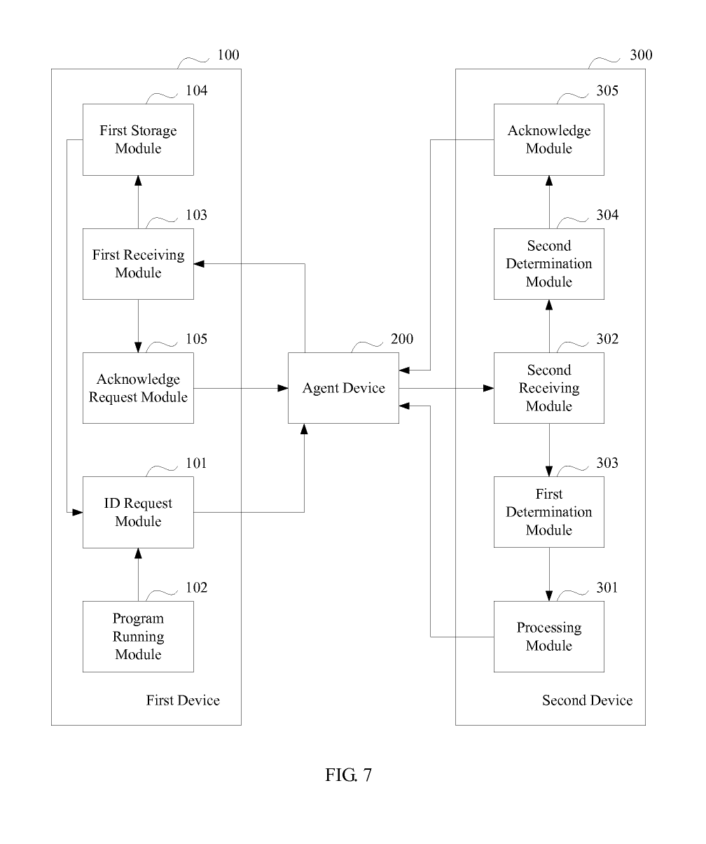

A system for obtaining ID information of an application service according to one embodiment of the invention is as shown in FIG. 7. The system includes a first device 100 and a second device 300.

The first device 100 includes an ID request module 101 adapted to send an ID request to the second device 300.

The second device 300 includes a processing module 301 adapted to return ID information of a target application service to the first device 100.

The system may further include an agent device 200 adapted to forward the ID request and ID information of an application service between the first device 100 and the second device 300.

The first device 100 includes:

a program running module 102, adapted to run an application;

the ID request module 101, adapted to send an ID request according to the application run by the program running module 102;

a first receiving module 103, adapted to receive the ID information of the application service; and

a first storage module 104, adapted to save the ID information of the application service received by the first receiving module 103.

During the implementation, the ID request module 101 may obtain the ID information of the application service from the first storage module 104, and carries the ID information of the application service in an ID request for sending.

When the program running module 102 needs to experience a certain service, the program running module 102 may obtain the ID information of the application service from the first storage module 104.

To guarantee the correctness of the ID information of the application service obtained from the first device 100, after the user terminal obtains the ID information of the application service, the first device 100 may verify the correctness of the ID information with the application service. Therefore, in this embodiment, the first device 100 further includes a verification request module 105 adapted to send a verification request to the second device 300 after the first receiving module 103 receives an ID information.

The second device 300 includes:

a second receiving module 302 adapted to receive information;

the processing module 301 adapted to send the ID information of the target application service, according to an ID request received by the second receiving module 302.

Because the second device 300 may first determine whether the ID information of the target application service is carried in the received ID request so as to decide to return the ID information of the target application service to the first device 100 or not, in this embodiment, the second device 300 further includes first determination module 303 adapted to determine whether the ID information of the target application service is carried in the ID request received by the second receiving module 302. When no ID information of the target application service is carried in the ID request, the processing module 301 is notified to send the ID information of the target application service.

Corresponding to the verification request module 105 of the first device 100, the second device 300 of this embodiment may further include a second determination module 304 and a verification module 305.

The second determination module 304 is adapted to determine whether the verification request received by the second receiving module 302 carries the ID information of the target application service and notify the verification module 305.

If the notification is that no ID information of the target application service is carried in the verification request, the verification module 305 sends a conflict response; otherwise, the verification module 305 sends a correctness response.

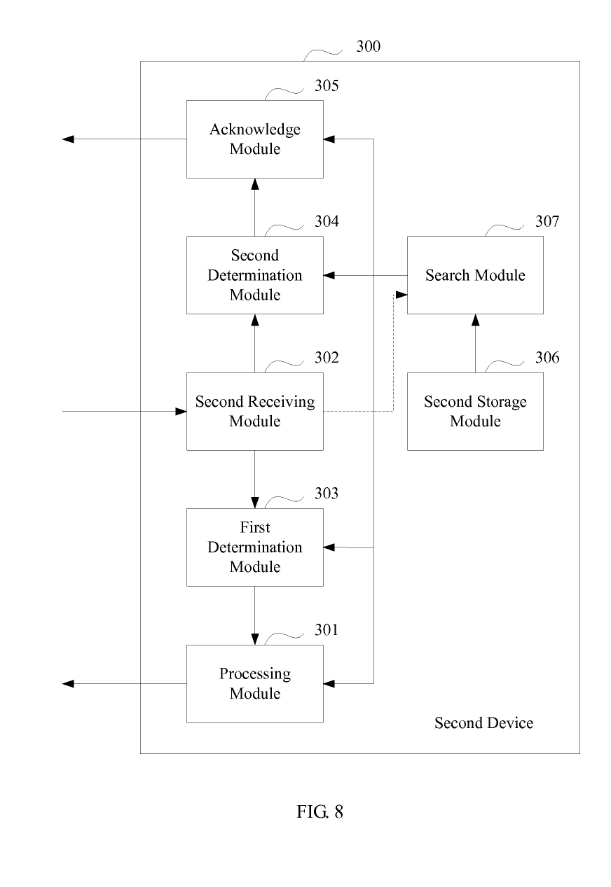

During the specific implementation, the second device 300 may be the target application service, or may be the concentrate service. When the second device 300 is the concentrate service, as shown in FIG. 8, the second device further includes:

a second storage module 306, adapted to save a mapping table for identifying the mapping relationship between the information of the application type and the ID information of the application service; and

a search module 307, adapted to search the mapping table according to an ID request received by the second receiving module 302, and obtain and output the ID information of the target application service.

When the second device 300 is the concentrate service, each of the processing module 301, first determination module 303, the second determination module 304, and the verification module 305 can obtain the ID information of the target application service from the search module 307.

In conclusion, in the embodiments of the invention, a first device sends an ID request to a second device, and the second device returns the ID information of the target application service to the first device. According to the technical solutions of the embodiments of the invention, by sending an ID request to the second device, the first device may automatically obtain the ID information of the target application service. Therefore, a user does not need to manually input the complex and complicated ID information of the application service when experiencing a service in which the ID information of the corresponding application service needs to be provided, and the user experience satisfaction may be improved.

Additional advantages and modifications will readily occur to those skilled in the art. Therefore, the invention in its broader aspects is not limited to the specific details and representative embodiments shown and described herein. Accordingly, various modifications and variations may be made without departing from scope of the invention as defined by the appended claims and their equivalents.

What is claimed is:

1. A method for obtaining ID information of an application service, comprising:
receiving, by an agent device, an ID request from a first device;
sending, by the agent device, the ID request to a second device;
receiving, by the agent device, an ID information of a target application service from the second device; and
returning, by the agent device, the ID information of the target application service to the first device.

2. The method according to claim 1, wherein the ID request carries the ID information of the application service suggested by the first device, and the method further comprises:
determining, by the second device, whether suggested ID information is the ID information of the target application service after receiving the ID request; if the suggested ID information is not the ID information of the target application service, returning the ID information of the target application service to the first device; and
receiving and saving, by the first device, the ID information of the target application service.

3. The method according to claim 2, wherein the suggested ID information comprises ID information of an application service saved locally in the first device or ID information of an initial application service of the first device.

4. The method according to claim 1, comprising directly receiving, by the first device, the ID information of the target application service from the second device after the second device receiving the ID request.

5. The method according to claim 2, comprising:
sending, by the first device, a verification request carrying the ID information received, to the second device after receiving the ID information; and
determining, by the second device, whether the ID information carried in the verification request is correct; if the ID information carried in the verification request is correct, returning a correctness response to the first device; otherwise, returning a conflict response to the first device.

6. The method according to claim 5, wherein the conflict response carries the ID information of the target application service; and the method further comprises: resolving and saving, by the first device, the ID information and resending a verification request to the second device after receiving the conflict response.

7. The method according to claim 2, wherein the ID request carries information of an application type requested by the first device.

8. The method according to claim 7, comprising sending, by the agent device, the request to the second device according to the information of the application type carried in the ID request, wherein the second device is the target application service corresponding to the application type.

9. The method according to claim 7, comprising:
saving, by the second device, a mapping relationship between the information of the application type and the ID information of the application service on the second device; and
obtaining, by the second device, the ID information of the target application service according to the information of the application type and the mapping relation after receiving the ID request.

10. A system for obtaining ID information of an application service, comprising:
a first device, which comprises an ID request module and is adapted to send an ID request to a second device; and
a second device, which comprises a processing module and is adapted to return ID information of a target application service to the first device.

11. The system according to claim 10, wherein the second device further comprises a first determination module, adapted to determine whether the ID request carries the ID information of the target application service and to notify the processing module to return the ID information of the target application service to the first device when the ID request does not carry the ID information of the target application service.

12. The system according to claim 10, wherein the first device further comprises:
a first receiving module, adapted to receive the ID information of the application service returned by the second device; and
a first storage module, adapted to save the ID information of the application service received by the first receiving module.

13. The system according to claim 12, wherein the first device further comprises a verification request module adapted to send a verification request to the second device after the first receiving module receives the ID information.

14. The system according to claim 13, wherein the second device further comprises a second determination module and a verification module, wherein:
the second determination module is adapted to determine whether the verification request carries the ID information of the target application service and notify the verification module; and
if the verification module is notified that the verification request does not carry the ID information of the target application service, the verification module sends a conflict response to the first device; otherwise, the verification module sends a correctness response to the first device.

15. The system according to claim 10, wherein the system further comprises an agent device adapted to forward the ID request and the ID information of the application service between the first device and the second device.

16. The system according to claim 15, wherein:
the second device is the target application service; and
the ID request module carries information of an application type corresponding to the target application service in the ID request and sends the ID request to the agent device, and the agent device sends the ID request to the second device according to the information of the application type.

17. The system according to claim 10, wherein the second device further comprises:
a second storage module, adapted to save a mapping table indicating a mapping relation between the information of the application type and the ID information of the application service; and
a search module adapted to search the mapping table according to the ID request, and obtain and output the ID information of the target application service.

18. A terminal, comprising a module adapted to run an application, wherein the terminal further comprises an ID request module adapted to send an ID request, according to the application.

19. The terminal according to claim 18, wherein the terminal further comprises:
a first receiving module adapted to receive ID information of an application service; and
a first storage module adapted to save the ID information of the application service received by the first receiving module.

20. The terminal according to claim 19, wherein the terminal further comprises a verification request module adapted to send a verification request after the first receiving module receives the ID information.

21. A device comprising a second receiving module adapted to receive information, wherein the device further comprises a processing module adapted to send ID information of a target application service, according to an ID request received by the second receiving module.

22. The device according to claim 21, wherein the device further comprises a first determination module adapted to determine whether the ID request received by the second receiving module carries the ID information of the target application service, and notify the processing module to send the ID information of the target application service when the ID request does not carry the ID information of the target application service.

23. The device according to claim 21, wherein the device further comprises a second determination module and a verification module, wherein:
the second determination module is adapted to determine whether a verification request received by the second receiving module carries the ID information of the target application service and notify the verification module; and
if the verification module is notified that the verification request does not carry the ID information of the target application service, the verification module sends a conflict response; otherwise, the verification module sends a correctness response.

24. The device according to claim 21, wherein the device is the target application service.

25. The device according to claim 21, further comprising:
a second storage module, adapted to save a mapping table indicating a mapping relationship between information of an application type and ID information of an application service; and
a search module adapted to search the mapping table according to the ID request received by the second receiving module, and obtain and output the ID information of the target application service.
